(19) United States
(12) Patent Application Publication
(10) Pub. No.: US 2009/0189032 A1
(43) Pub. Date: Jul. 30, 2009

(54) MONITOR ATTITUDE ADJUSTMENT APPARATUS

(75) Inventor: Yi Chung Su, Taipei (TW)

Correspondence Address: G. LINK CO., LTD., 3550 BELL ROAD, MINOOKA, IL, 60447, US

(73) Assignee: EVER CASE TECHNOLOGY INC., TAIPEI (TW)

(21) Appl. No.: 12/046,703

(22) Filed: Mar. 12, 2008

(30) Foreign Application Priority Data
Jan. 29, 2008 (CN) 200810006305.8

(51) Int. Cl. F16M 11/04; G05B 11/01

(52) U.S. Cl. 248/179.1; 700/13

(57) ABSTRACT

A monitor attitude adjustment apparatus used in an electronic apparatus comprises a mount base; an attitude adjusting mechanism consisting of a plurality of actuating devices, each actuating device comprising a driver and a displacement mechanism, the driver being the force source for driving the movement of corresponding displacement mechanism, and each displacement mechanism having a constrained degree of freedom for mechanical motion; and a suspension mount with one end mechanically connected to the attitude adjusting mechanism and the other end securing the electronic apparatus; wherein the actuating devices in the attitude adjusting mechanism constitute an integrated mechanical state and the position or orientation of the electronic apparatus corresponds to the integrated mechanical state of the attitude adjusting mechanism.

### FIELD OF THE INVENTION

The present invention relates to a monitor attitude adjustment apparatus, more particularly a device with the characteristics of multi-axis mechanism and actuating force to drive the movement of respective axial mechanisms.

### BACKGROUND OF THE INVENTION

Conventional monitor attitude adjustment apparatus for electronic device is provide for the setup of CRT monitor, flat panel display, PDA, satellite navigation device and other electronic devices, which also enables the adjustment of the position or viewing angle of the electronic device to facilitate operation or viewing by the user by adjusting the attitude of the adjustment mechanism.

Spurred by the dawning of digital age and the prevalence of the Internet, liquid crystal display (LCD) monitors have become the mainstream choice for computer monitor and home television, given their advantages of lightweight, thin form, power saving and free of radiation. Generally a stand is needed for the placement of LCD monitor on a desk for support and fixation or the adjustment of monitor angle.

In recent years, LCD monitor stand and LCD are commonly separately fabricated and then assembled. When a stand-included LCD monitor is placed on a desk, it is also easy to adjust its tilting angles.

The recent trend is that LCD monitors marketed by different makers are increasing in size. More and more large-size and heavier LCD monitors are in mass production. When large-size LCD monitor is assembled to the stand, the weight of the monitor would impede the manual operation of the monitor attitude adjustment apparatus, causing inconvenience to the user.

In addition, if a manually-operated monitor attitude adjustment apparatus is used in a showroom or an exhibition, it is greatly inconvenient when it becomes necessary to adjust the monitor for onsite presentation or demonstration. If there is a control that provides actuating force and automated operation, it will render the product display more animated and improve the operatability of the monitor attitude adjustment apparatus.

To address the drawbacks of conventional monitor attitude adjustment apparatus, the present invention aims to provide a kind of monitor attitude adjustment apparatus with actuating power and user interface.

### SUMMARY OF THE INVENTION

The primary object of the invention is to provide a monitor attitude adjustment apparatus comprising a multi-axis mechanism, a plurality of drivers to provide actuating force, and an input unit as user (human-machine) interface to set up and adjust the attitude of electronic devices.

Another object of the invention is to provide a monitor attitude adjustment apparatus that employs easily operated rotary force output apparatus, such as a motor to achieve an attitude adjustment mechanism capable of linear displacement and having two rotation axes orthogonal to each other in axial direction.

Yet another object of the invention is to provide a monitor attitude adjustment apparatus that enables remote control via the wireless transmission of a user interface, thereby enhancing the operatability of monitor attitude adjustment apparatus.

A further object of the invention is to provide a monitor attitude adjustment apparatus with a control unit for the control of the monitor attitude adjustment apparatus, and the control unit is programmable.

Yet another object of the invention is to provide a monitor attitude adjustment apparatus comprising a sensor unit for the feedback control of the monitor attitude adjustment apparatus.

To achieve the aforesaid objects, the present invention provides a monitor attitude adjustment apparatus used in setup of an electronic apparatus and comprising a mount base; an attitude adjusting mechanism consisting of a plurality of actuating devices, each actuating device comprising a driver and a displacement mechanism, the drivers being the force source for driving the movement of corresponding displacement mechanism, and each displacement mechanism having a constrained degree of freedom for mechanical motion; and a suspension mount with one end mechanically connected to the attitude adjusting mechanism and the other end securing the electronic apparatus; wherein the actuating devices in the attitude adjusting mechanism constitute an integrated mechanical state and the position or orientation of the electronic apparatus corresponds to the integrated mechanical state of the attitude adjusting mechanism.

The input unit further consists of a remote control and a receiver. The remote control is a human-machine interface using wireless transmission and converts the inputted operating signal into a wireless signal for output according to a wireless transmission protocol. The receiver receives the wireless signal output by the remote control and converts the wireless signal received into corresponding electrical signal to provide target information to the control unit for the control of attitude adjustment mechanism.

The wireless transmission protocol adopted by the remote control and the receiver is infrared wireless transmission protocol.

The control unit includes a programmable module to provide control of the attitude adjustment mechanism and the logic computation needed.

The logic computation of the control unit includes recording or setting built-in mechanical attitudes to be provided via the input unit for the operation of the attitude adjustment mechanism.

The monitor attitude adjustment apparatus further comprises a sensor unit, the sensor unit sends an electrical signal corresponding to the state of the attitude adjustment mechanism to the control unit, which in turn outputs a control signal corresponding to the drivers of the attitude adjustment mechanism.

The sensor unit further comprises an encoder, the encoder being a driver in the actuating device and feeding back a corresponding electrical signal to the control unit, which in turn outputs a control signal corresponding to the driver.

The sensor unit further comprises an encoder, the encoder being a displacement mechanism in the actuating device and feeding back a corresponding electrical signal to the control unit, which in turn outputs a control signal corresponding to the driver in the actuating device.

In the plurality of actuating devices in the attitude adjustment mechanism, there is provided a first actuating device, the first actuating device outputting a force for linear motion, and the linear motional force output end of said first actuating device being mechanically connected to the suspension mount. The first actuating device further comprises a first driver and a first displacement mechanism, the first driver being a force source, and the first displacement mechanism being a mechanism that converts the force from the first driver into a force for linear motion for output. The first driver outputs a rotary force, while the first displacement mechanism converts the rotary motion into linear motion.

The first displacement mechanism further comprises a plurality of rear arms, a plurality of front arms and a plurality of first transmission mechanisms, wherein one end of each rear arm is pivotally attached to the mount base, its other end is pivotally connected to one end of a corresponding front arm, the other ends of the front arms are pivotally connected to each other and mechanically attached to the suspension mount, the first transmission mechanisms are mechanically connected to the corresponding rear arms and the force output end of the first driver, and the place at where the front arms are pivotally connected has a constrained degree of freedom for linear motion.

The first transmission mechanism further comprises a plurality of gears corresponding to the rear arms, the gears being respectively securely disposed on the corresponding rear arms, and the corresponding rear arms being co-axially pivotally attached to the mount base. The force output end of the first driver engages the gears of the rear arms, and the rotary force from the first driver is transmitted to the corresponding rear arms through the gears.

The first actuating device comprises a force source and a force conversion mechanism that confines the degree of freedom at the output end to linear motion.

The first actuating device is selected from the group consisting of hydraulic cylinder, pneumatic cylinder, and electric cylinder.

In the plurality of actuating devices in the attitude adjustment mechanism, there is provided a second actuating device, the second actuating device outputting a force for rotary motion and being pivotally connected to the linear motional force output end of the first actuating device, and the suspension mount being mechanically connected to the rotary motional force output end of the second actuating device.

The second actuating device further comprises a second driver and a second displacement mechanism, the second driver being a force source, and the second displacement mechanism being a mechanism that converts the force from the second driver into a rotary motional force for output.

The second driver outputs a rotary force. The second displacement mechanism is a pivotal rod body, the pivotal rod body being mechanically attached to the suspension mount, and the suspension mount being pivotally connected to the linear motional force output end of the first actuating device via the pivotal rod body.

In the plurality of actuating devices in the attitude adjustment mechanism, there is provided a third actuating device, the third actuating device outputting a force for rotary motion and being pivotally connected to the rotary motional force output end of the second actuating device, and the suspension mount being mechanically connected to the rotary motional force output end of the third actuating device.

The direction of the rotary motional force of the second actuating device is orthogonal to that of the rotary motional force of the third actuating device.

The third actuating device further comprises a third driver and a third displacement mechanism, the third driver being a force source, and the third displacement mechanism being a mechanism that converts the force from the third driver into a rotary motional force for output.

The third driver outputs rotary force. The third displacement mechanism further comprises a vertical rotary rod, a horizontal rotary rod, and a third transmission mechanism, wherein the vertical rotary rod has a plurality of vertical pivotal members, and through which, is pivotally connected to the pivotal rod body in the second displacement mechanism of the second actuating device; the horizontal rotary rod has a horizontal pivotal member, and through which, is pivotally connected to the vertical rotary rod, the transmission direction of the horizontal pivotal member being orthogonal to that of the vertical pivotal member; the third transmission mechanism is securely coupled to the horizontal rotary rod, and the third driver is mechanically securely coupled to the vertical rotary rod such that the force output by the third driver is converted to rotary motional force through the third transmission mechanism, which drives the rotation of the horizontal rotary rod using the horizontal pivotal member as fulcrum.

The suspension mount is further mechanically fastened to the horizontal rotary rod and mechanically constrains the horizontal pivotal member through the third driver of the third actuating device. The vertical rotary rod is securely disposed on the horizontal rotary rod and securely connected to the pivotal rod body of the second actuating device through the horizontal pivotal member of the horizontal rotary rod.

The third transmission mechanism in the third displacement mechanism further contains an arc-shaped rod body and a tooth member, the arc-shaped rod body being an arc-shaped rod with a downward opening and the tooth member being formed on a surface of the arc-shaped rod body and engaging the force output end of the third driver in the third actuating device.

The monitor attitude adjustment apparatus further comprises a sensor unit, the sensor unit sends an electrical signal corresponding to the state of the attitude adjustment mechanism to the control unit, which in turn outputs a control signal corresponding to the drivers of the attitude adjustment mechanism.

The sensor unit further comprises an encoder, the encoder being a driver in the actuating device and feeding back a corresponding electrical signal to the control unit, which in turn outputs a control signal corresponding to the driver.

The sensor unit further comprises an encoder, the encoder being a displacement mechanism in the actuating device and feeding back a corresponding electrical signal to the control unit, which in turn outputs a control signal corresponding to the driver in the actuating device.

The input unit further consists of a remote control. The remote control is a human-machine interface using wireless transmission and provides target information to the control unit for the control of attitude adjustment mechanism. The control unit would, based on the electrical information fed back by the sensor unit, output a control signal to respective drivers.

The objects, features and effects of the invention are described in detail below with embodiments in reference to the accompanying drawings.

### BRIEF DESCRIPTION OF THE DRAWINGS

FIG. 1 is a perspective view of the monitor attitude adjustment apparatus according to an embodiment of the invention;

FIG. 2 is a partial exploded view of the monitor attitude adjustment apparatus according to an embodiment of the invention;

FIG. 3 is a top view of the monitor attitude adjustment apparatus according to an embodiment of the invention;

FIG. 4 is a partial exploded view of the monitor attitude adjustment apparatus according to an embodiment of the invention;

FIG. 5 is a partial perspective view of the monitor attitude adjustment apparatus according to an embodiment of the invention;

FIG. 6 is a partial perspective view of the monitor attitude adjustment apparatus according to an embodiment of the invention;

FIG. 7 is a partial perspective view of the monitor attitude adjustment apparatus according to an embodiment of the invention;

FIG. 8 is a side view of the monitor attitude adjustment apparatus according to an embodiment of the invention; and

FIG. 9 is a component diagram of the monitor attitude adjustment apparatus according to an embodiment of the invention.

### DETAILED DESCRIPTION OF THE INVENTION

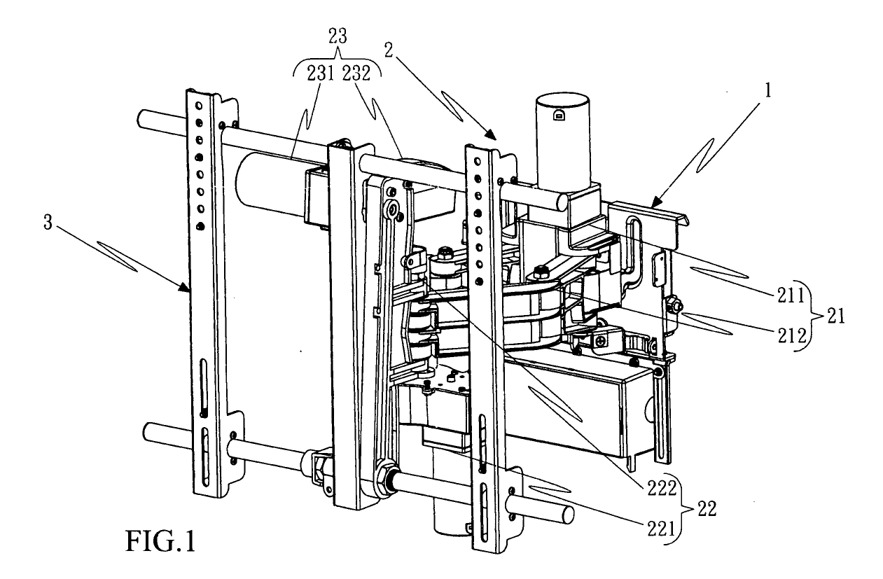

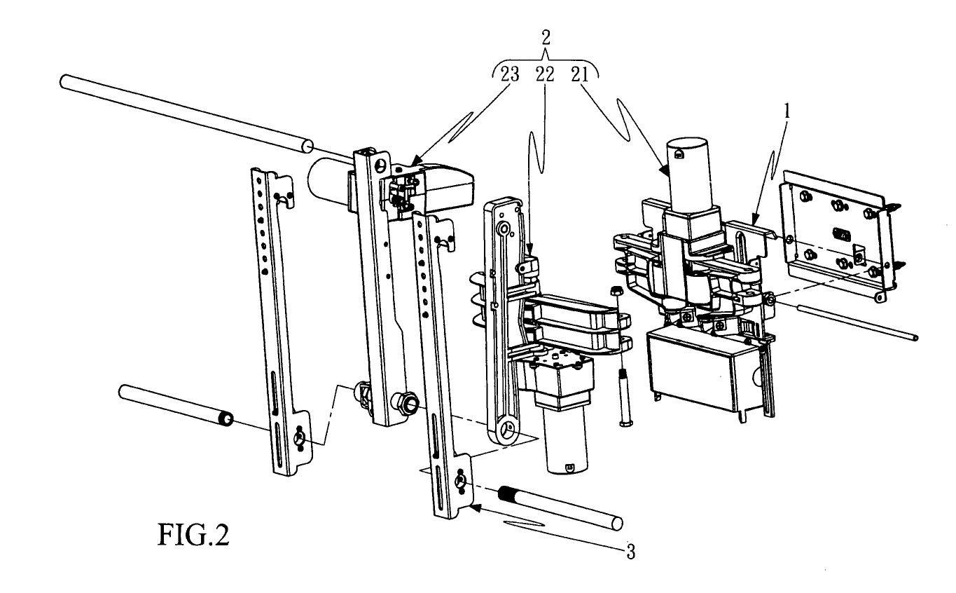

Referring to FIG. 1 and FIG. 2, FIG. 1 is a perspective view of the monitor attitude adjustment apparatus according to an embodiment of the invention, and FIG. 2 is a partial exploded view of the monitor attitude adjustment apparatus according to an embodiment of the invention. As shown, the monitor attitude adjustment apparatus comprising a mount base (1) which is mechanically connected to a suspension mount (3) through an attitude adjustment mechanism (2) is provided for the setup of an electronic device. Such electronic device is a display, PDA, or satellite navigation device where its position or orientation can be adjusted by changing the mechanical attitude of the attitude adjustment mechanism (2) to make it convenient for user to operate or view the electronic device. A part of the mount base (1) can be mounted on an object, such as wall surface or any structure. The attitude adjustment mechanism (2) comprises a plurality of actuating devices, each actuating device consisting of a driver and a specific motional mechanism and having a degree of freedom for mechanical motion such that the integration of actuating devices in varying mechanical states forms a specific state of attitude for the attitude adjustment mechanism (2), thereby adjusting the position or orientation of the electronic device. One end surface of the suspension mount (3) is mechanically connected to the attitude adjustment mechanism (2), while its other end provides for the mounting of the electronic device.

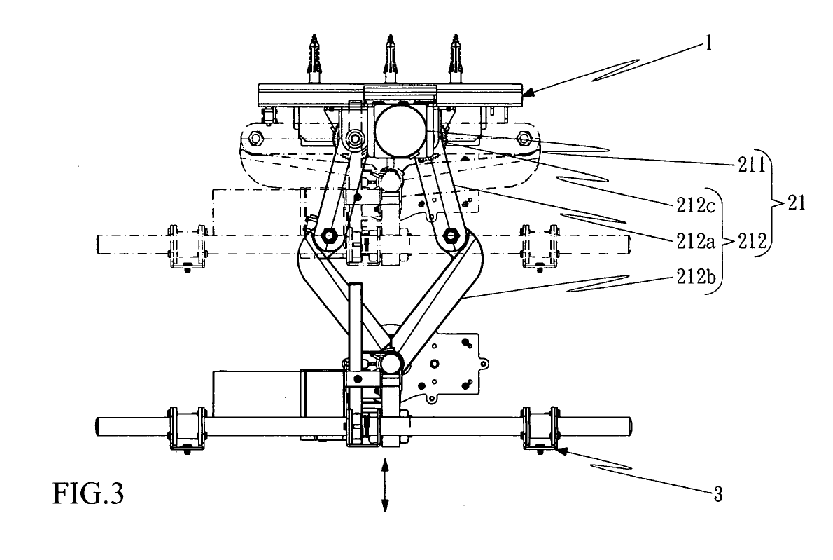

FIG. 3 is a top view of the monitor attitude adjustment apparatus according to an embodiment of the invention. As shown in FIGS. 1, 2 and 3, the attitude adjustment mechanism (2) comprises a first actuating device (21), the first actuating device (21) having a force source and a moving mechanism, and capable of outputting a linear motional force to enable the linear forward or backward movement of the suspension mount (3). For example, the first actuating device (21) can be a hydraulic cylinder, a pneumatic cylinder or an electric cylinder, or a force conversion mechanism that uses a force source and is able to limit the degree of freedom at output end to linear motion. Moreover, the linear motion end of the first actuating device (21) is mechanically connected to the suspension mount (3) to drive the linear motion of the suspension mount (3), thereby achieving the change of position attitude.

Based on the embodiment of the monitor attitude adjustment apparatus described above, the first actuating device (21) consists of a first driver (211) and a first displacement mechanism (212), the first driver (211) being a force source, and the first displacement mechanism (212) converting the force from the first driver (211) into a linear motional force for output. More specifically, the first driver (211) of the first actuating device (21) is a driver capable of outputting rotary force, such as a server motor, and the first displacement mechanism (212) is a mechanism capable of converting the rotary motion into linear motion, and further comprises a plurality of rear arms (212a), a plurality of front arms (212b), and a plurality of first transmission mechanisms (212c), wherein one end of each rear arm (212a) is pivotally attached to the mount base (1), its other end is pivotally connected to one end of a corresponding front arm (212b), the other ends of the front arms (212b) are pivotally connected to each other and mechanically attached to the suspension mount (3), the first transmission mechanisms (212c) are mechanically connected to the corresponding rear arms (212a) and the force output end of the first driver (211) such that the force output by the first driver (211) can drive the corresponding rear arm (212a) via the first transmission mechanism (212c). In the mechanism comprising the plurality of rear arms (212a) and the plurality of front arms (212b), the place at where the front arms (212b) are pivotally connected to each other has a constrained degree of freedom for linear motion. Thus, when the first driver (211) drives the first transmission mechanism (212c) and the rear arms (212a) carry out synchronous rotary motion, the pivot axis of the front arms (212b) will generate corresponding linear motion. At the same time, the suspension mount (3) would also undergo linear motion as driven by the front arms (212b). The linear motion is as depicted by the arrows in the figure, while variations of the positions of rear arms (212a), front arms (212b), and suspension mount (3) are as illustrated by the solid lines and dashed lines in the figure.

The first transmission mechanism (212c) in the first displacement mechanism (212) of the first actuating device (21) comprises a plurality of gears corresponding to the rear arms (212a), the gears being respectively securely disposed to the rear arms (212a) and co-axially pivotally connected to the mount base (1) with the respective rear arms (212a). The force output end of the first driver (211) in the first actuating device (21) engages the gears of the rear arms (212a) such that the rotary force from the first driver (211) is transmitted to the corresponding rear arms (212a) through the gears.

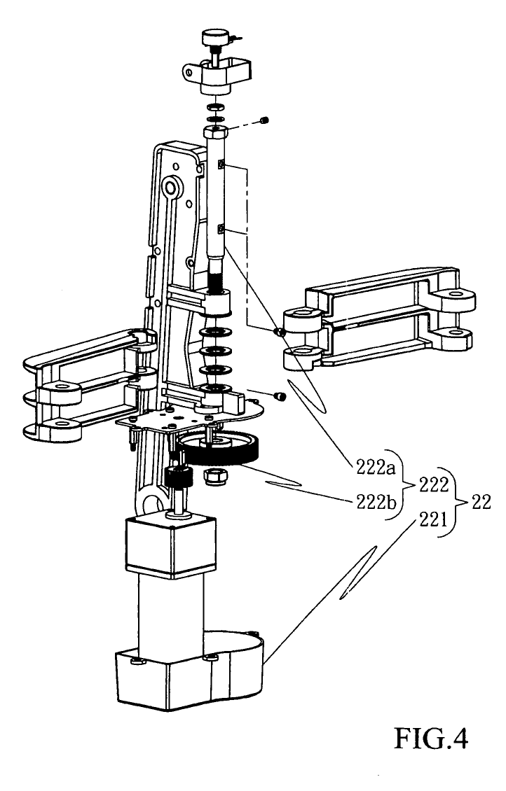

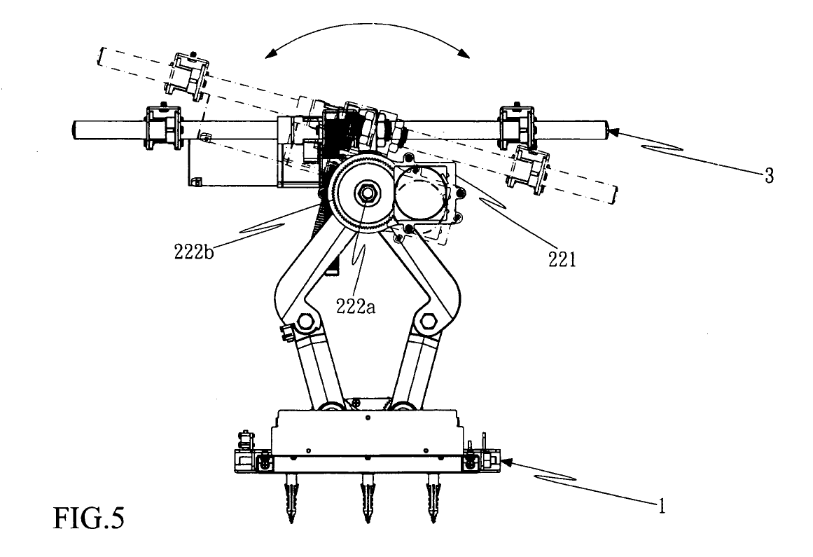

FIG. 4 is a partial exploded view of the monitor attitude adjustment apparatus according to an embodiment of the invention. FIG. 5 is a partial perspective view of the monitor attitude adjustment apparatus according to an embodiment of the invention. As shown in FIGS. 1, 2, 4 and 5, in the attitude adjustment mechanism (2) of the embodiment, the suspension mount (3) is pivotally connected to the linear motion end of the first actuating device (21). The attitude adjustment mechanism (2) further comprises a second actuating device (22), the second actuating device (22) having a force source and a moving mechanism, and capable of outputting a rotary motional force to control the rotary attitude of the suspension mount (3). For example, the second actuating device (22) is a motor or a force conversion mechanism that uses a force source and is able to limit the degree of freedom at output end to rotary motion. Moreover, the rotary motion end of the second actuating device (22) is mechanically connected to the suspension mount (3) to drive the rotary motion of the suspension mount (3), thereby achieving the change of angle attitude.

Based on the embodiment of the monitor attitude adjustment apparatus described above, the second actuating device (22) consists of a second driver (221) and a second displacement mechanism (222), the second driver (221) being a force source, and the second displacement mechanism (222) converting the force from the second driver (221) into a rotary motional force for output. More specifically, the second driver (221) of the second actuating device (22) is a driver capable of outputting rotary force, such as a server motor, and the second displacement mechanism (222) is a pivotal rod body (222a), the pivotal rod body (222a) being mechanically connected to the suspension mount (3), and the suspension mount (3) being pivotally connected to the linear motion end of the first actuating device (21) through the pivotal rod body (222a). As such, the second driver (221) can drive the rotation of the suspension mount (3) through the pivotal rod body (222a). The rotary motion is as depicted by the arrows in the figure, while the variation of the angle of suspension mount (3) is as illustrated by the solid lines and dashed lines in the figure.

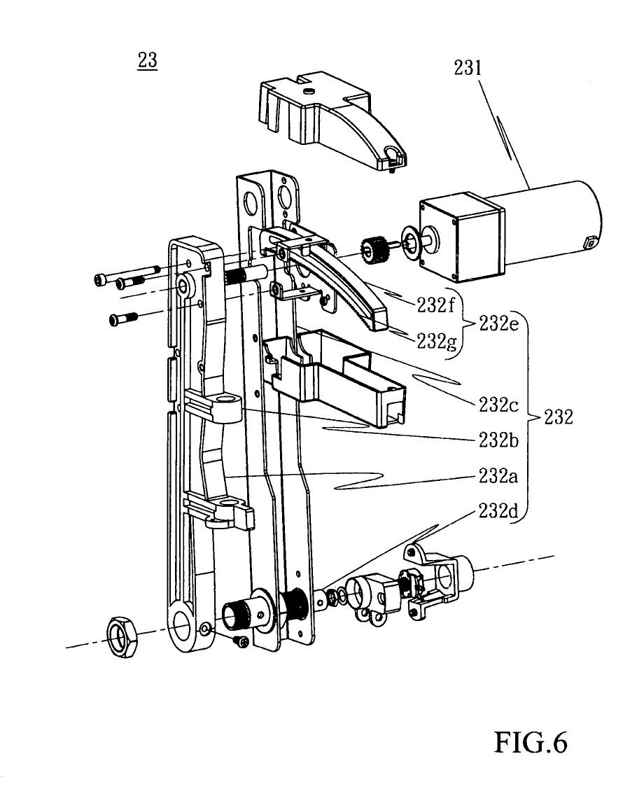

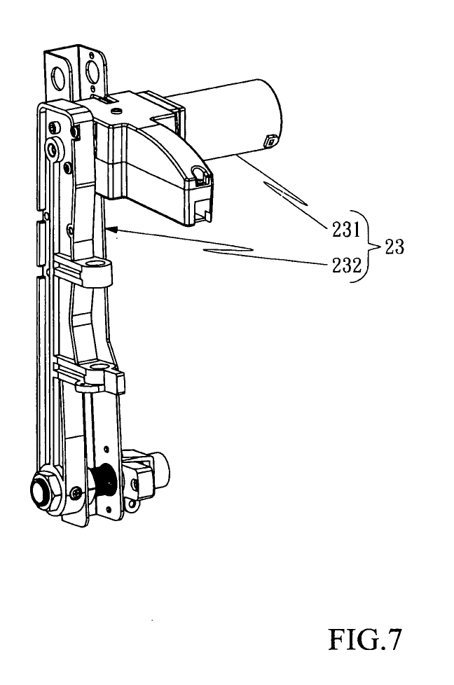

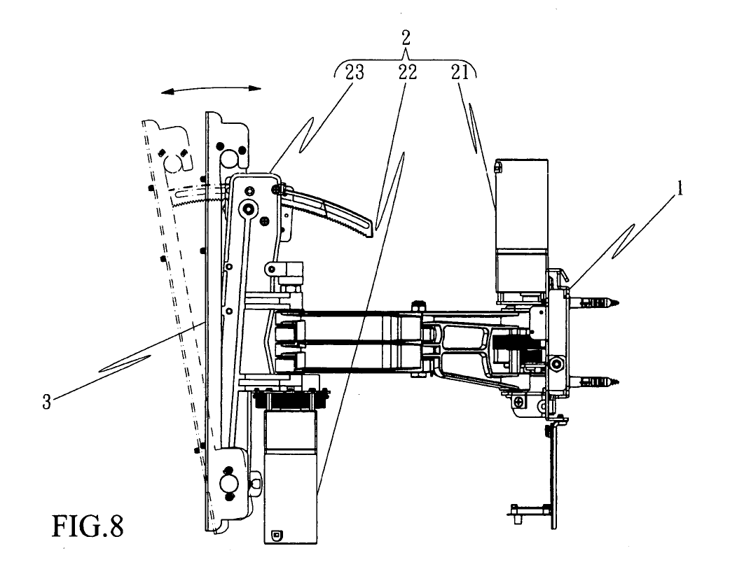

FIG. 6 is a partial perspective view of the monitor attitude adjustment apparatus according to an embodiment of the invention; FIG. 7 is a partial perspective view of the monitor attitude adjustment apparatus according to an embodiment of the invention; and FIG. 8 is a side view of the monitor attitude adjustment apparatus according to an embodiment of the invention. As shown in FIGS. 1, 2, 6, 7 and 8, in the attitude adjustment mechanism (2) of the embodiment, the suspension mount (3) is pivotally connected to the rotary motion end of the second actuating device (22). The attitude adjustment mechanism (2) further comprises a third actuating device (23), the third actuating device (23) having a force source and a moving mechanism, and capable of outputting a rotary motional force orthogonal to the rotational axis of the second actuating device (22) to allow the suspension mount (3) to control its rotation. For example, the second actuating device (22) generates rotary motion in vertical direction, and the third actuating device (23) is a motor or a force conversion mechanism that uses a force source and is able to limit the degree of freedom at output end to rotary motion in horizontal direction. Moreover, the rotary motion end of the third actuating device (23) is mechanically connected to the suspension mount (3) to drive the horizontal rotation of the suspension mount (3), thereby achieving the change of rotational angle attitude in horizontal direction.

Based on the embodiment of the monitor attitude adjustment mechanism described above, the third actuating device (23) consists of a third driver (231) and a third displacement mechanism (232), the third driver (231) being a force source, and the third displacement mechanism (232) converting the force from the third driver (231) into a rotary motional force for output. More specifically, the third driver (231) of the third actuating device (23) is a driver capable of outputting rotary force, such as a server motor, and the third displacement mechanism (232) further consists of a vertical rotary rod (232a), a horizontal rotary rod (232c), and a third transmission mechanism (232e), wherein the vertical rotary rod (232a) has a plurality of vertical pivotal members (232b), and through which, is pivotally connected to the pivotal rod body (222a) in the second displacement mechanism (222) of the second actuating device (22); the horizontal rotary rod (232c) has a horizontal pivotal member (232d), and through which, is pivotally connected to the vertical rotary rod (232a), the transmission direction of the horizontal pivotal member (232d) being orthogonal to that of the vertical pivotal member (232b); the third transmission mechanism (232e) is securely coupled to the horizontal rotary rod (232c), and the third driver (231) is mechanically attached to the vertical rotary rod (232a) such that the force output by the third driver (231) is converted to rotary motional force through the third transmission mechanism (232e), which drives the rotation of the horizontal rotary rod (232c) using the horizontal pivotal member (232d) as fulcrum. The suspension mount (3) is further mechanically fastened to the horizontal rotary rod (232c) and mechanically constrains the horizontal pivotal member (232d) through the third driver (231) of the third actuating device (23). The vertical rotary rod (232a) is securely disposed on the horizontal rotary rod (232c) and securely connected to the pivotal rod body (222a) of the second actuating device (22) through the horizontal pivotal member (232d) of the horizontal rotary rod (232c). Thus the suspension mount (3) can be pivotally connected to the output end of the first displacement mechanism (212) of the first actuating device (21). As such, the suspension mount (3) can engage in linear displacement and rotary displacement in two pivotal directions orthogonal to each other, and through the integration of the mechanical motions, the position or orientation of the electronic device mounted on the suspension mount (3) can be adjusted.

The third transmission mechanism (232e) in the third displacement mechanism (232) further contains an arc-shaped rod body (232f) and a tooth member (232g), the arc-shaped rod body (232f) being an arc-shape rod body with a downward opening and the tooth member (232g) being formed on a inner arc surface of the arc-shaped rod body (232f) and engaging the force output end of the third driver (231) in the third actuating device (23) such that the rotary force output by the third driver (231) can drive the tooth member (232g) and cause the suspension mount (3) to generate corresponding pivotal rotation in horizontal direction. The rotary motion is as depicted by the arrows in the figure, while the variation of the angle of suspension mount (3) is as illustrated by the solid lines and dashed lines in the figure.

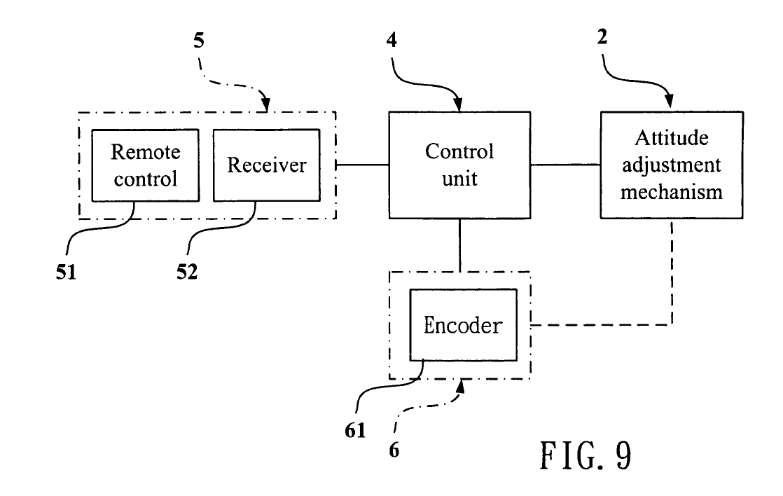

FIG. 9 is a component diagram of the monitor attitude adjustment apparatus according to an embodiment of the invention. As shown, the monitor attitude adjustment apparatus further comprises a control unit (4), an input unit (5) and a sensor unit (6). The control unit (4) can perform the logic computation of electrical data and provide a control signal on the first driver (211), second driver (221) or third driver (231). The input unit (5) provides the user with an interface to operate the first driver (211), second driver (221) or third driver (231). The sensor unit (6) sends an electrical signal corresponding to the state in the attitude adjustment mechanism (2) to the control unit (4) to provide information on the state of the attitude adjustment mechanism (2) to the control unit (4), which in turn outputs a control signal corresponding to the first driver (211), second driver (221) or third driver (231).

The sensor unit (6) further comprises an encoder (61). As shown in FIG. 3, the encoder (61) is disposed on the horizontal pivotal member (232d) in the horizontal rotary rod (232c) of the third displacement mechanism (232) in the third actuating device (23), and the encoder (61) is able to feed back an electrical signal corresponding to the pivotal rotational angle of the horizontal pivotal member (232d) to the control unit (4) to provide information on the state of the attitude adjustment mechanism (2) to the control unit (4), which in turn outputs a control signal corresponding to the third driver (231).

In addition, one or more encoders (61) can be disposed on any rotational element in the first actuating device (21), second actuating device (22) and third actuating device (23) such that the encoders (61) can detect the mechanical state of the corresponding element (the relative angular positions of the elements) and feed back such information to the control unit (4) so that the attitude state of the attitude adjustment mechanism (2) can be obtained. The control unit (4) then outputs a control signal corresponding to the third driver (231) to achieve feedback control.

The input unit (5) further consists of a remote control (51) and a receiver (52). The remote control (51) is a human-machine interface and converts the operating signal input by the user into a wireless signal for output according to a wireless transmission protocol. The receiver (52) receives the wireless signal output by the remote control (51) and converts the wireless signal received into corresponding electrical signal to enable the user to define and control the attitude state of the attitude adjustment mechanism (2) by wireless means via the remote control (51) and provide target information to the control unit (4) for the control of attitude adjustment mechanism (2). The control unit (4) in turn outputs a control signal corresponding to the first driver (211), second driver (221) or third driver (231) based on the electrical information fed back by the sensor unit (6).

The wireless transmission protocol adopted by the remote control (51) and the receiver (52) of the input unit (5) is infrared wireless transmission protocol. The control of the axial movements of the monitor attitude adjustment apparatus is achieved based on the incident direction or change of position of the infrared wireless signal emitted by the remote control (51) as input into the receiver (52). The logic computation of the control unit (4) entails computing the input direction in the receiver (52) or change of input position based on the electrical signal provided by the receiver (52). The control unit (4) then outputs a corresponding control signal to control the axial movements of the monitor attitude adjustment apparatus.

The control unit (4) includes a programmable module to provide the control and logic computation needed by the monitor attitude adjustment apparatus. Thus automated operation of the monitor attitude adjustment apparatus can be achieved via the control unit (4). In addition, the control unit (4) can record or set built-in mechanical attitudes that can be chosen by to the user via the input unit (5) for the operation of the monitor attitude adjustment apparatus.

The preferred embodiments of the present invention have been disclosed in the examples. However the examples should not be construed as a limitation on the actual applicable scope of the invention, and as such, all modifications and alterations without departing from the spirits of the invention and appended claims shall remain within the protected scope and claims of the invention.

What is claimed is:

1. A monitor attitude adjustment apparatus for use in an electronic device, comprising:
a mount base;
an attitude adjustment mechanism comprising a plurality of actuating devices, each actuating device consisting of a driver and a displacement mechanism, the driver being the force source for driving the movement of corresponding displacement mechanism, and each displacement mechanism having a constrained degree of freedom for mechanical motion;
a suspension mount with one end surface being mechanically connected to the attitude adjustment mechanism, and the other end providing for the mounting of the electronic device;
a control unit providing the logic computation of electrical data and a controller; and
an input unit being a human-machine interface;
wherein the actuating devices in the attitude adjusting mechanism constitute an integrated mechanical state and the position or orientation of the electronic apparatus corresponds to the integrated mechanical state of the attitude adjusting mechanism; the control unit carries out the control of the monitor attitude adjustment apparatus based on the built-in control information and the electrical information provided by the input unit.

2. The monitor attitude adjustment apparatus according to claim 1, wherein the input unit further consists of a remote control and a receiver, the remote control being a human-machine interface using wireless transmission and converting the inputted operating signal into a wireless signal for output according to a wireless transmission protocol, the receiver receiving the wireless signal output by the remote control and converting the wireless signal received into corresponding electrical signal to provide target information to the control unit for the control of the attitude adjustment mechanism.

3. The monitor attitude adjustment apparatus according to claim 2, wherein the wireless transmission protocol adopted by the remote control and the receiver is infrared wireless transmission protocol.

4. The monitor attitude adjustment apparatus according to claim 3, wherein the control unit comprises a programmable module to provide the control and logic computation needed by the attitude adjustment mechanism.

5. The monitor attitude adjustment apparatus according to claim 4, wherein the logic computation of the control unit includes recording or setting built-in mechanical attitudes to be provided via the input unit for the operation of the attitude adjustment mechanism.

6. The monitor attitude adjustment apparatus according to claim 1, further comprising a sensor unit, the sensor unit sending an electrical signal corresponding to the state of the attitude adjustment mechanism to the control unit, the control unit in turn outputting a control signal corresponding to the drivers of the attitude adjustment mechanism.

7. The monitor attitude adjustment apparatus according to claim 6, wherein the sensor unit further comprises an encoder, the encoder being a driver in the actuating device and feeding back a corresponding electrical signal to the control unit, the control unit in turn outputting a control signal corresponding to the driver.

8. The monitor attitude adjustment apparatus according to claim 6, wherein the sensor unit further comprises an encoder, the encoder being a displacement mechanism in the actuating device and feeding back a corresponding electrical signal to the control unit, the control unit in turn outputting a control signal corresponding to the driver in the actuating device.

9. The monitor attitude adjustment apparatus according to claim 1, wherein the plurality of actuating devices in the attitude adjustment mechanism include a first actuating device, the first actuating device outputting a linear motional force, and the linear motional force output end of the first actuating device being mechanically connected to the suspension mount.

10. The monitor attitude adjustment apparatus according to claim 9, wherein the first actuating device further comprises a first driver and a first displacement mechanism, the first driver being a force source, and the first displacement mechanism being a mechanism that converts the force from the first driver into a force for linear motion for output.

11. The monitor attitude adjustment apparatus according to claim 10, wherein the first driver outputs a rotary force, whereas the first displacement mechanism converts the rotary motion into linear motion.

12. The monitor attitude adjustment apparatus according to claim 11, wherein the first displacement mechanism further comprises a plurality of rear arms, a plurality of front arms and a plurality of first transmission mechanisms, one end of each rear arm being pivotally attached to the mount base, its other end being pivotally connected to one end of a corresponding front arm, the other ends of the front arms being pivotally connected to each other and mechanically attached to the suspension mount, the first transmission mechanisms being mechanically connected to the corresponding rear arms and the force output end of the first driver, and the place at where the front arms are pivotally connected having a constrained degree of freedom for linear motion.

13. The monitor attitude adjustment apparatus according to claim 12, wherein the first transmission mechanism further comprises a plurality of gears corresponding to the rear arms, the gears being respectively securely disposed on the corresponding rear arms, and the corresponding rear arms being co-axially pivotally attached to the mount base, the force output end of the first driver engaging the gears of the rear arms, and the rotary force from the first driver being transmitted to the corresponding rear arms through the gears.

14. The monitor attitude adjustment apparatus according to claim 9, wherein the first actuating device comprises a force source and a force conversion mechanism that confines the degree of freedom at the output end to linear motion.

15. The monitor attitude adjustment apparatus according to claim 9, wherein the first actuating device is selected from the group consisting of hydraulic cylinder, pneumatic cylinder, and electric cylinder.

16. The monitor attitude adjustment apparatus according to claim 9, wherein the plurality of actuating devices in the attitude adjustment mechanism include a second actuating device, the second actuating device outputting a force for rotary motion and being pivotally connected to the linear motional force output end of the first actuating device, and the suspension mount being mechanically connected to the rotary motional force output end of the second actuating device.

17. The monitor attitude adjustment apparatus according to claim 16, wherein the second actuating device further comprises a second driver and a second displacement mechanism, the second driver being a force source, and the second displacement mechanism being a mechanism that converts the force from the second driver into a rotary motional force for output.

18. The monitor attitude adjustment apparatus according to claim 17, wherein the second driver outputs a rotary force, and the second displacement mechanism is a pivotal rod body, the pivotal rod body being mechanically attached to the suspension mount, and the suspension mount being pivotally connected to the linear motional force output end of the first actuating device via the pivotal rod body.

19. The monitor attitude adjustment apparatus according to claim 16, wherein the plurality of actuating devices in the attitude adjustment mechanism includes a third actuating device, the third actuating device outputting a force for rotary motion and being pivotally connected to the rotary motional force output end of the second actuating device, and the suspension mount being mechanically connected to the rotary motional force output end of the third actuating device.

20. The monitor attitude adjustment apparatus according to claim 19, wherein the direction of the rotary motional force of the second actuating device is orthogonal to that of the rotary motional force of the third actuating device.

21. The monitor attitude adjustment apparatus according to claim 19, wherein the third actuating device further comprises a third driver and a third displacement mechanism, the third driver being a force source, and the third displacement mechanism being a mechanism that converts the force from the third driver into a rotary motional force for output.

22. The monitor attitude adjustment apparatus according to claim 21, wherein the third driver outputs rotary force, and the third displacement mechanism further comprises a vertical rotary rod, a horizontal rotary rod, and a third transmission mechanism, wherein the vertical rotary rod has a plurality of vertical pivotal members, and through which, is pivotally connected to the pivotal rod body in the second displacement mechanism of the second actuating device; the horizontal rotary rod has a horizontal pivotal member, and through which, is pivotally connected to the vertical rotary rod, the transmission direction of the horizontal pivotal member being orthogonal to that of the vertical pivotal member; the third transmission mechanism is securely coupled to the horizontal rotary rod, and the third driver is mechanically securely coupled to the vertical rotary rod such that the force output by the third driver is converted to rotary motional force through the third transmission mechanism, which drives the rotation of the horizontal rotary rod using the horizontal pivotal member as fulcrum.

23. The monitor attitude adjustment apparatus according to claim 22, wherein the suspension mount is further mechanically fastened to the horizontal rotary rod and mechanically constrains the horizontal pivotal member through the third driver of the third actuating device, the vertical rotary rod being securely disposed on the horizontal rotary rod and securely connected to the pivotal rod body of the second actuating device through the horizontal pivotal member of the horizontal rotary rod.

24. The monitor attitude adjustment apparatus according to claim 23, wherein the third transmission mechanism in the third displacement mechanism further contains an arc-shaped rod body and a tooth member, the arc-shaped rod body being an arc-shaped rod with a downward opening and the tooth member being formed on a surface of the arc-shaped rod body and engaging the force output end of the third driver in the third actuating device.
